(19) United States
(12) Patent Application Publication
(10) Pub. No.: US 2008/0130525 A1
(43) Pub. Date: Jun. 5, 2008

(54) Video conferencing with archival notes

(75) Inventors: Gail Jansen, Santa Ynez, CA (US); Les Ousley, Santa Barbara, CA (US); Olga Ilinichna Olivia Agapova, Santa Barbara, CA (US); Alexey Simon Ushakov, Santa Barbara, CA (US)

Correspondence Address: CARR & FERRELL LLP, 2200 GENG ROAD, PALO ALTO, CA, 94303, US

(73) Assignee: Total Comco, Inc.

(21) Appl. No.: 12/012,044

(22) Filed: Jan. 30, 2008

Related U.S. Application Data
(63) Continuation-in-part of application No. 11/390,656, filed on Mar. 27, 2006.
(60) Provisional application No. 60/666,083, filed on Mar. 28, 2005.

(51) Int. Cl. H04Q 11/04

(52) U.S. Cl. 370/260

(57) ABSTRACT

A text interface for recording archived notes in a video conference session is provided. Archived notes may comprise an updatable, modifiable record created or modified during one or more instances of a conference session. The archived notes may be saved from a previous instance of the conference session and retrieved at the commencement of a subsequent instance of the conference session. The archived notes and the concurrent notes may be edited by the participants in the conference session. A note area displayed within a layout allows one or more of the participants of the conference session to provide, modify, and/or view concurrent notes and archived notes.

### CROSS-REFERENCES

This U.S. Nonprovisional patent application is a Continuation-In-Part of U.S. Nonprovisional patent application Ser. No. 11/390,656 filed Mar. 27, 2006 and entitled, “System and Method of Communicating Media Signals in a Network,” which claims the priority benefit of U.S. Provisional Patent Application No. 60/666,083 filed Mar. 28, 2005 and entitled “System and Method of Communicating Media Signals in a Network,” both of which are incorporated herein by reference.

### BACKGROUND

1. Field of the Invention

Embodiments of the present invention relate generally to video conferencing, and more specifically to providing archival notes in a video conference.

2. Description of the Related Art

Currently, video conferencing technologies are limited to video and audio content. Typically, a video camera or “webcam” connected to a computer is used to capture and transmit the video content to other participants. For example, the participants may conduct a series of video conferences, such as a weekly meeting, over a period of several weeks.

However, participants may desire to write messages to one another and/or record the contents of the video conference in the form of minutes. Currently, participants may use separate chat programs, such as AOL Instant Messenger, alongside the video conference. However, not all participants may be able to see what is written, and the messages are not editable once displayed to the other users. Additionally, each of the participants may save their notes associated with each video conference separately from other participants. Furthermore, the display of the chat program may overlap the video of the other participants or require the user to awkwardly shuffle between the video conference and the chat program.

Therefore there is a need for a text interface in a video conference that overcomes at least the above limitations.

### SUMMARY

A text interface for storing archived notes in a conference session is provided. Archived notes comprise updatable, modifiable records created during one or more instances of the conference session. The conference session also includes audio and video data of one or more participants. The archival notes may be saved from a previous instance of the conference session and retrieved at the commencement of a subsequent instance of the conference session. During an instance of a conference session, each of the participants may view and/or modify the archived notes. Further, each of the participants may provide concurrent notes during the instance of the conference session. At the end of the conference session, the archived notes and the concurrent notes are stored.

The conference session, or an instance of the conference session, is associated with a layout. The layout defines the size, shape, and/or position of the video data and the notes within a display. A note area displayed within the layout allows one or more of the participants of the conference session to provide and/or view concurrent notes.

### BRIEF DESCRIPTION OF THE DRAWINGS

FIG. 1 illustrates an exemplary environment in which various embodiments of the invention may be practiced;

FIG. 2 is a block diagram of an exemplary computer in the environment of FIG. 1 according to various embodiments of the invention;

FIG. 3 is a block diagram of an exemplary conference center according to various embodiments of the invention;

FIG. 4 is a flowchart of a process for providing a conference session according to various embodiments of the invention;

FIG. 5 illustrates a first exemplary layout according to various embodiments of the invention; and

FIG. 6 illustrates a second exemplary layout according to various embodiments of the invention.

### DETAILED DESCRIPTION

Systems and methods for providing archived notes associated with a conference session are provided. The conference session is typically a video conference between two or more participants. The conference session may comprise, for example, a class, a legal proceeding, a business meeting, a social interaction between friends or family, or the like. The conference session may be divided into multiple instances occurring over a period of time. For example, a seven-week class may meet once a week. Each weekly meeting is an instance of the conference session. In this example, there are seven instances of the conference session. To initiate an instance of a conference session, access to audio and video data of one or more other participants and archived notes from a previous instance of the conference session is provided to a participant. The initiated instance of the conference session may be referred to as “a current instance” of the conference session. Audio and video data of the participant and concurrent notes provided by the participant and/or other participants during the current instance of the conference session are communicated to other participants. Other users may view, edit, or add to the concurrent notes and/or the archived notes. At the end of the instance of the conference session, the concurrent notes and the archived notes are stored such that they can be displayed later in a subsequent instance of the conference session.

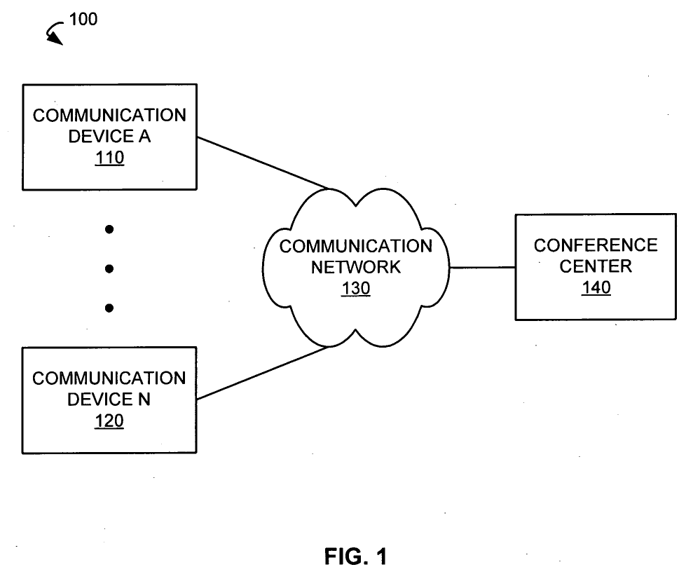

FIG. 1 illustrates an exemplary environment 100 in which various embodiments of the invention may be practiced. The environment 100 comprises two or more communication devices, such as communication device A 110 and communication device N 120, a communication network 130, and a conference center 140. The communication device A 110, the communication device N 120, and the conference center 140 are communicatively coupled to the communication network 130. In an exemplary embodiment, the communication network 130 comprises a wide area network (WAN), local area network (LAN), or the like. The communication network 130, according to various embodiments, comprises the Internet. It is understood that the environment 100 may comprise any number of communication devices similar to the communication device A 110.

A first participant and a second participant of a video conference, or an instance thereof, communicate with one another using the communication device A 110 and the communication device N 120, respectively. The communication device A 110 and the communication device N 120 may each comprise a personal digital device such as a laptop or a desktop, a personal digital assistant (PDA), or a mobile telephone. The communication device A 110 and communication device N 120 are configured to capture audio and video data, and transmit the audio and video data to the conference center 140 via the communication network 130. Further, the communication device A 110 is configured to receive audio and video data captured by the communication device N 120 via the conference center 140, and play the received audio and video data to the first participant, and vice-versa.

The communication device A 110 and the communication device N 120 additionally may include a keyboard that allows a participant to input text data. Exemplary embodiments are further discussed in U.S. Nonprovisional patent application Ser. No. 11/390,656 filed Mar. 27, 2006 and entitled, “System and Method of Communicating Media Signals in a Network” and incorporated by reference herein.

The exemplary conference center 140 is configured to receive the audio data, the video data, and archive data captured by the communication device A 110 during a conference session. In some embodiments, the conference center 140 may edit the audio data, the video data, and/or the archive data. The edited audio and video data may include fade-ins, fade-outs, subtitles, voice-overs, adjustments to audio and/or video, or the like. The edited (or unedited) audio data, video data, and archive data is transmit to other computers, such as communication device A 110, associated with the same conference session.

In some embodiments, the conference center 140 is configured to identify a conference session based on a uniform resource locator (URL) associated with the conference session. Because the conference session is associated with a URL rather than a date and time, the conference session may include two or more instances. The two or more instances are portions of the video conference that take place at various times. To illustrate, a conference session may be associated with a series of weekly calendar meetings. Each week, at a predetermined time, the participants may navigate to the URL associated with the conference session. A current instance of the conference session begins when a participant is provided access to the audio data, video data, and/or text data associated with the conference session.

In various embodiments, the archive data includes, but is not limited to, text, drawing, sketching, digital images, and audio. The archive data is stored from instance to instance of the conference session as archived notes. The archived notes may include, for example, meeting minutes, class notes, project timeliness or the like. During the current instance of the conference session, concurrent notes may be added to the archived notes, the archived notes may be edited, or portions of the archived notes may be deleted. According to some embodiments, at the end of the current instance or when the last participant navigates away from the URL address, updated archived notes are stored by the conference center 140. Later, when a subsequent instance is initiated, the updated archived notes are provided to the participants.

The conference center 140 may include a data center and/or media control center as described in U.S. Nonprovisional patent application Ser. No. 11/390,656 filed Mar. 27, 2006 and entitled, “System and Method of Communicating Media Signals in a Network” and incorporated herein.

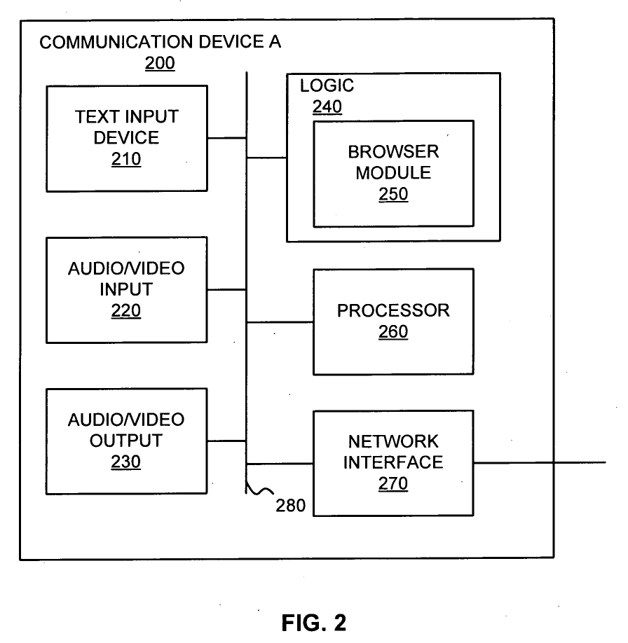

FIG. 2 is a block diagram of an exemplary communication device A 110 in the environment of FIG. 1 according to various embodiments of the invention. The communication device A 110 may comprises a text input device 210, an audio/video input 220, an audio/video output 230, logic 240 including a browser module 250, a processor 260, and a network interface 270 configured to communicate via a communication bus 280. The communication device A 110 may comprise one or more computing devices including computer readable media, a processor, and/or logic.

The text input device 210 may comprise a keyboard, such as a QWERTY keyboard, a telephone number pad, or other type of text input device or graphical user interface known to those skilled in the art. The audio/video input 220 may comprise a camera configured to capture video data and/or a microphone configured to capture audio data. The audio/video output 230 may comprise a video display such as a monitor, a screen, or the like. The audio/video output 230 additionally may include one or more speakers.

In some embodiments, the logic 240 comprises the browser module 250. The browser module 250 may, alternatively, comprise instructions embodied in a computer readable medium. The exemplary browser module 250 comprises a browser as is known in the art. Examples of browsers include Microsoft Explorer, Mozilla Firefox, Safari, Opera, and Netscape. The browser may be configured to receive multi-media presentations, such as presentations requiring a FLASH-enabled or Java-enabled browser.

The processor 260 is configured to execute instructions embodied on a computer readable media or logic such as logic 240. The network interface 270 is configured to communicate via the communication network 130. The network interface 270 may comprise, for example, an Ethernet interface, a Wireless Fidelity (WiFi) interface, a telephony interface, a cellular communications interface, or the like. Other network interfaces will be apparent to those skilled in the art.

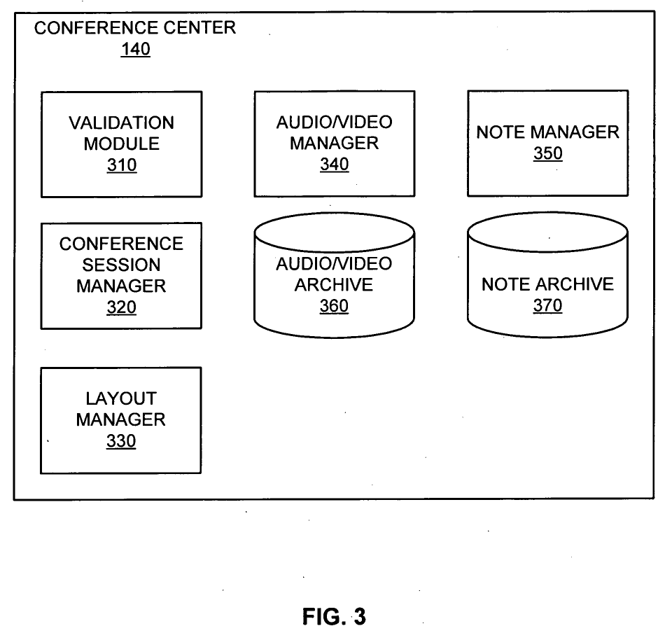

FIG. 3 is a block diagram of the exemplary conference center 140 according to various embodiments of the invention. The conference center 140 may comprise a validation module 310, a conference session manager 320, a layout manager 330, an audio/video manager 340, a note manager 350, an audio/video archive 360, and a note archive 370.

The conference center 140 may comprise one or more computing devices including computer readable media, a processor, and/or logic. For example, the conference center 140 may comprise a processor configured to execute computing instructions stored in the computer readable medium. These instructions may be embodied in software. In some embodiments; the computer readable medium comprises an IC memory chip, such as, for example, static random access memory (SRAM), dynamic random access memory (DRAM), synchronous DRAM (SDRAM), non-volatile random access memory (NVRAM), and read only memory (ROM), such as erasable programmable ROM (EPROM), electrically erasable programmable ROM (EEPROM), and flash memory. Alternatively, the conference center 140 may comprise one or more chips with logic circuitry, such as, for example, an application specific integrated circuit (ASIC), a processor, a microprocessor, a microcontroller, a field programmable gate array (FPGA), a programmable logic device (PLD), a complex programmable logic device (CPLD), or other logic device.

The validation module 310 is configured to verify login information associated with a conference session from a participant. In an exemplary embodiment, the login information is received from the participant who has navigated to the URL of the video conference. The login information may include a user name, password, pin number, and/or the like. In some embodiments, the participant may login to other conference sessions by navigating to another URL and entering in the same login information. The validation module 310 then compares the received login information with stored login information to verify the participant. In some embodiments, the validation module 310 may be optional.

The conference session manager 320 is configured to provide access to the conference session associated with the URL. In exemplary embodiments, the participant may be verified by the validation module 310 as being eligible to participate in the conference session. Once verified, the conference session manager 320 is notified to allow the participant to access the conference session. In some embodiments, access to the conference session may be controlled by providing access to the conference session to specified participants. For example, a class conference session may be limited only to students who have paid tuition.

In exemplary embodiments, the conference session manager 320 is configured to assign a token or session identifier to each conference session or the current instance of each conference session being hosted by the conference center 140. As a result, the conference center 140 may host multiple conference sessions from a single IP address.

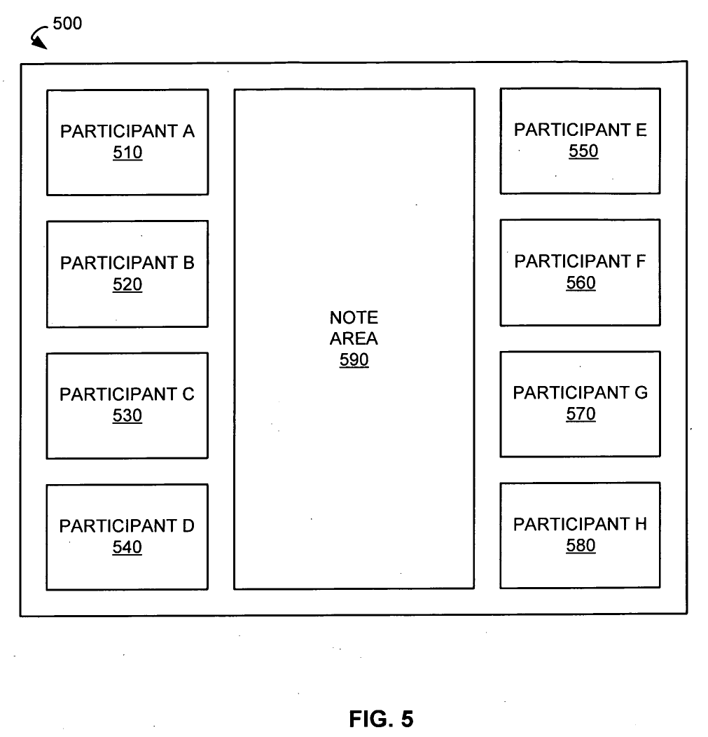

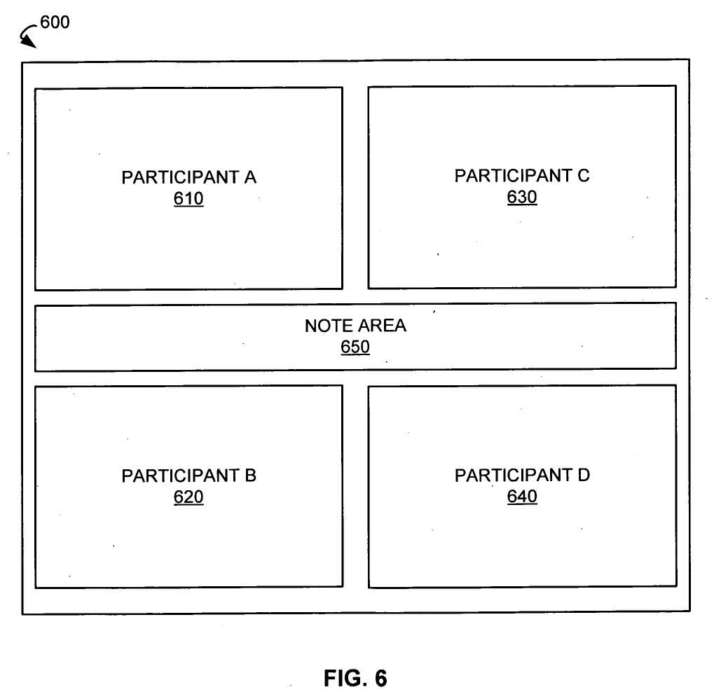

The layout manager 330 is configured to modify a layout based on instructions received from the participant. The layout may comprise the size, shape, and/or location of a note area, a video (or still) image of one or more of the participants, or the like. Exemplary layouts are discussed herein, at least, in connection with FIGS. 5 and 6. In some embodiments, the layout manager 330 may provide a layout management interface to a participant acting as a moderator. The moderator may be the participant who initiated the conference session or may be associated with a role, such as a teacher in a classroom setting. In some embodiments, the layout manager 330 may be optional.

In exemplary embodiments, the layout management interface provided by the layout manager 330 allows the moderator to change the appearance of the conference session at, for example, communication device A 110 and communication device N 120. The layout may be selected based on the type of conference session being conducted. The layout manager 330 may provide a set of templates from which the moderator selects a layout. In some embodiments, the moderator may be able to input a layout using the layout management interface as will be apparent to those skilled in the art.

The audio/video manager 340 is configured to communicate audio and video data associated with the conference session so that the participants may see and hear the other participants. For example, the audio/video manager 340 receives the audio/video data from the communication device A 110 and sends the received audio/video data to communication device N 120 and vice-versa. In some embodiments, the audio/video manager 340 may send at least the received video data back to communication device A 110 such that the participant using the communication device A 110 may see herself or himself. The audio/video manager 340 may be configured to communicate the audio and video data using a programming language such as FLASH, Java, or the like.

In some embodiments, the audio/video manager 340 is configured to store the audio and video data associated with a conference session in an audio/video archive 360. To allow the participants to view past instances of the conference session, the audio and video data may later be accessed by the audio/video manager 340. The audio and video data may be stored in the audio/video archive 360 in various multimedia file formats as will be apparent to those skilled in the art.

The exemplary note manager 350 is configured to communicate notes associated with the conference session. The notes may include archived notes and/or concurrent notes. In some embodiments, the notes appear to each of the participants in the current instance of the conference session.

Changes made during any instance of the conference session by a participant using, for example, communication device A 110 are received by the note manager 350. The note manager 350 updates the notes as viewed by the other participants (e.g., a participant using communication device N 120). The update may include sending changes between the archived notes and the concurrent notes to the communication device A 110 and the communication device N 120. The note manager 350 may provide the update as concurrent notes are received or on a periodic basis (e.g., every second).

The changes made to the concurrent notes and/or the archived notes during an instance of the conference session include additions, insertions, and/or deletions. To allow other participants to collaborate on generating a single set of notes for the conference session, the participants may change notes submitted by other participants. In some embodiments, the one or more of the participants may not have permission to change archived notes from a previous instance of the conference session.

The note archive 370 is configured to store the archived notes of one or more conference sessions. At the end of an instance of the conference session, concurrent notes may be added to the note archive 370 so that the note archive 370 now include the concurrent notes. It should be noted that, in some embodiments, the audio/video archive 360 and the note archive 370 may be combined within a single database storage or archive.

It should be noted that the conference center 140 of FIG. 3 is exemplary. Alternative embodiments may comprise fewer or more modules, storages, or the like as will be apparent to one skilled in the art.

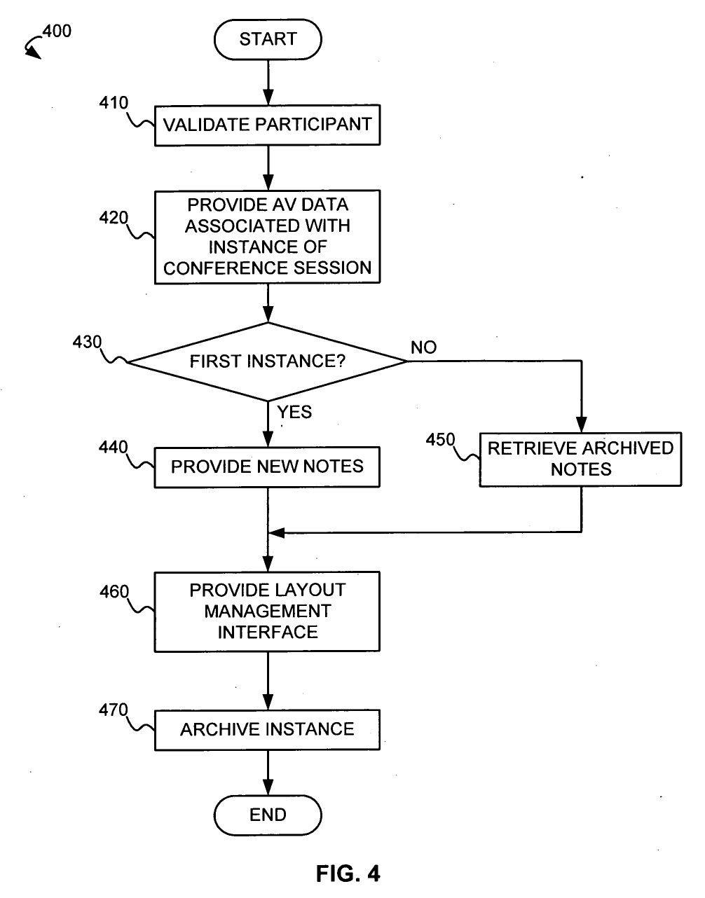

FIG. 4 is a flowchart of a process 400 for providing a conference session according to various embodiments of the present invention. The process 400 may be performed by the conference center 140.

In step 410, a participant is validated. The participant, using, for example, a browser in communication device A 110, navigates to a URL associated with the conference session. At a webpage associated with the URL, the participant provides login information such as a username, email address, password, personal identification number (PIN), or the like. The validation module 310 compares the login information to stored login information to validate or verify the user. The validation may also comprise determining whether the participant is allowed to join the conference session associated with the URL. For example, a list of allowed participants may be associated with the validation process. In some embodiments, step 410 may be optional.

In step 420, audio and video data received from other participants associated with the conference session is provided to the participant. Further, audio and video data of the participant may be provided to other participants in a current instance of the conference session. If the participant is the first or only participant in the conference session, the audio and video data is limited to the audio and video data of the participant.

In step 430, a determination is made as to whether the current instance of the conference session is a first instance of the conference session. If the current instance is the first instance, new notes are provided to the participants in step 440. New notes may comprise, e.g., an empty text field, a formatted text field, a form, a graphics field, or the like.

If, however, the current instance is a subsequent instance of the conference session, the archived notes from a previous instance are retrieved in step 450. The archived notes may be retrieved from the note archive 370 in the conference center 140. In some embodiments, the archived notes may be stored according to the URL of the conference session.

In step 460, a layout management interface is provided. In exemplary embodiments, the layout management interface is provided by the layout manager 330. The layout management interface may be provided to each participant or only to a moderator. The layout management interface allows a participant to change the appearance of the conference session. The layout may be the same for each of the participants. In some embodiments, step 460 is optional.

In step 470, the current instance of the conference session is archived. The notes within a note area, or accessible via the note area within the conference session, may be stored. The notes may include archived notes and concurrent notes. If there are concurrent notes, the concurrent notes may be added to the previously archived notes in the note archive 370. In some embodiments, the audio and/or video data associated with the current instance of the conference session may also be archived in the audio/video archive 360. The step 470 may be performed at the end of the current instance of the conference session or repeatedly throughout the instance.

Referring now to FIG. 5, a first exemplary layout 500 according to various embodiments of the present invention is illustrated. The layout 500 depicts relative size, shape, and position of a note area and video display area of each participant. The video display areas display the video data of each participant. The layout 500 may comprise a template selected by the moderator or received as input from the moderator.

In the layout 500, the video display areas of eight participants, may be arranged on two sides of a larger note area. For example, participant A 510, participant B 520, participant C 530, and participant D 540 are arranged along a left side of the layout 500 and participant E 550, participant F 560, participant G 570, and participant H 580 are arranged along a right edge of the layout 500. It should be noted that each of the video display areas of the participants A-H 510-580 are approximately the same size and shape.

A larger note area 590 may extend vertically down a center of the layout 500. The note area 590 may be used to record minutes of a meeting, class notes, a current draft of a document, or the like. The note area 590 may include a scroll bar (not shown) to allow participants to view notes that do not fit within the note area 590. In exemplary embodiments, a participant may add or edit notes by selecting the note area 590 and entering text, graphics, or the like via a keyboard or other input device.

FIG. 6 illustrates a second exemplary layout 600 according to various embodiments of the present invention. The layout 600 depicts an alternative relative size, shape, and position of a note area and video display areas of each participant. The video display areas display the video data. The layout 600 may comprise a template selected by the moderator or received as input from the moderator. The layout 600 comprises the video display areas of four participants, participant A 610, participant B 620, participant C 630, and participant D 640 arranged around a smaller note area 650. The note area 650 may be used to record side comments in a social conversation, a meeting agenda, a snapshot, or the like.

It should be noted that FIG. 5 and FIG. 6 show exemplary layouts. Alternative embodiments may contemplate a different layout. For example, the video display areas of a particular participant may be larger or smaller than the video display areas of other participants. For example, the video display area of a teacher may be larger than the video display area of each of the students. Further, the video display areas and note area (e.g., note area 590 and note area 650) may comprise various shapes may be used within the layout such as ovals, squares, triangles, or the like. Additionally, the position of the video display area and note areas may be rearranged in alternative embodiments.

The above-described components and functions can be comprised of instructions that are stored on a computer-readable or machine-readable storage medium. The instructions can be retrieved and executed by a processor. Some examples of instructions are software, program code, and firmware. Some examples of storage medium are memory devices, tapes, disks, integrated circuits, and servers. The instructions are operational when executed by the processor to direct the processor to operate in accordance with the invention. Those skilled in the art are familiar with instructions, processors, and storage medium.

The present invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

What is claimed is:

1. A method for providing a conference session comprising:
providing access to audio data and video data associated with the conference session to a participant;
if archived notes are associated with the conference session, displaying the archived notes;
receiving concurrent notes from the participant; and
storing the concurrent notes as updated archived notes associated with the conference session.

2. The method of claim 1, further comprising allowing the participant to modify a layout of a first display area depicting the video data and a second display area depicting the concurrent notes.

3. The method of claim 2, wherein modifying the layout comprises changing a size of the first display or the second display.

4. The method of claim 2, wherein modifying the layout comprises changing a position of the first display or the second display.

5. The method of claim 1, further comprising receiving a modified layout of a first display and a second display from another participant and providing the modified layout to the participant.

6. The method of claim 1, further comprising receiving other concurrent notes from at least one other participant and providing access to the other concurrent notes to the participant.

7. The method of claim 1, further comprising receiving audio and video data from the participant.

8. The method of claim 1, wherein the updated archived notes comprise the archived notes and the concurrent notes.

9. The method of claim 1, further comprising associating the conference session with a session identifier.

10. The method of claim 1, further comprising associating the conference session with a uniform resource locator.

11. The method of claim 1, further comprising validating the participant to the conference session.

12. The method of claim 1, further comprising receiving a modification of the concurrent notes.

13. A system for providing a conference session comprising:
a conference session manager configured to provide access to the conference session;
an audio/video manager configured to communicate audio and video data associated with the conference session;
a note manager configured to provide archived notes and receive concurrent notes associated with the conference session; and
a note archive configured to store the archived notes and the concurrent notes associated with the conference session.

14. The system of claim 13, further comprising a layout manager configured to modify a layout based on an instruction received from a participant.

15. The system of claim 13, further comprising an audio/video archive configured to store audio/video data communicated by the audio/video manager.

16. The system of claim 13, wherein the audio/video manager and the note manager are configured to communicate with a FLASH-enabled browser.

17. The system of claim 13, wherein the audio/video manager and the note manager are configured to communicate with a JAVA-enabled browser.

18. The system of claim 13, wherein the conference session manager is configured to assign a session identifier to the conference session.

19. The system of claim 13, wherein the conference session manager is configured to assign a token identifier to the conference session.

20. The system of claim 13, wherein the conference session is accessible via a uniform resource locator using an Internet browser.

21. The system of claim 13, further comprising a validation module configured to verify login information associated with a conference session from a participant.

22. A computer-readable storage medium having embodied thereon a program, the program being executable by a processor for performing a method for providing a conference session, the method comprising:
providing access to audio data and video data associated with the conference session to a participant;
if archived notes are associated with the conference session, displaying the archived notes;
receiving concurrent notes from the participant; and
storing the concurrent notes as updated archived notes associated with the conference session.
